(19) United States
(12) Patent Application Publication
(10) Pub. No.: US 2008/0180255 A1
(43) Pub. Date: Jul. 31, 2008

(54) RFID tag

(76) Inventor: Michael James Isabell, Grand Rapids, MI (US)

Correspondence Address: Michael P. Fortkort PC, 13164 Lazy Glen Lane, Oak Hill, VA, 20171, US

(21) Appl. No.: 11/657,721

(22) Filed: Jan. 25, 2007

(51) Int. Cl. G08B 13/14; B29C 65/00

(52) U.S. Cl. 340/572.8; 156/60

(57) ABSTRACT

A method and system for making a label. The label can include a circuit disposed on a face of a substrate. The substrate may also contain printed indicia. The substrate may further be sealed using a laminate and an adhesive layer may be applied to a portion of the seal. The label may further include a release layer that covers the adhesive prior to adhering the label to a container.

### FIELD OF THE INVENTION

This invention relates generally to the field of a label incorporating an electronic component and in particular to a label having an RFID tag.

### BACKGROUND

The use of a radio frequency identification (RFID) to identify one of a plurality of items is well known. Typical radio frequency identification (RFID) tags or integrated circuits include a microprocessor, also known as a microchip, electrically connected to an antenna. Alternatively, the microchip is first attached to a pad having electrical leads that provides a larger attachment of “landing” area. This is typically referred to as a “strap” or “interposer.” The strap is then attached to the antenna.

The microprocessor stores data, which can include identifying data unique to a specific item, which is transmitted to an external receiver for reading by an operator and processing of the item. RFID tags can be attached to items for inventory control, shipment control, and the like. RFID tags are particularly useful in identifying, tracking and controlling items such as packages, pallets, and other product containers. The location of each item can be tracked and information identifying the owner of the item or specific handling requirements, can be encoded into the RFID and later read by a scanning device capable of decoding and displaying the information.

RFID tags have been incorporated into a pressure sensitive adhesive-backed label for items contained in temporary packaging, such as cardboard cartons, or containers which are to undergo a number of reuses, such as pallets, waste containers, shipment containers and the like. These labels are conventionally fabricated by attaching an antenna made of metal foil or other suitable material to a substrate material such as paper, film and the like, also referred to as an inlay substrate. A microprocessor or strap is attached to the substrate in cooperative disposition with the antenna to form what is typically referred to as an inlay. An adhesive is then applied to the surface of the inlay substrate over the antenna and microprocessor, and the inlay substrate is attached to a label substrate, on which text and graphics can be imprinted, so that the adhesive, antenna and microprocessor are sandwiched between the inlay substrate and the label substrate. A layer of adhesive is then applied to the surface of the label substrate over the inlay, followed by the addition of a release layer over the adhesive. The laminate can then be die cut to the finished label size. Printing of a bar code or other information, text and graphics onto the finished label, and coding of the microprocessor can take place before or after the die cutting step. The labels are then wound tightly onto a spool or processed into a fan-fold configuration for shipment to a customer or return to the electronic manufacturer or marketer. The application of the inlay to the paper is usually carried out by an electronic manufacturer and the remaining steps are typically carried out by a label manufacturer.

The handling of the inlay during this label making process imposes stresses on the inlay which can result in damage to the microprocessor. In addition, the inlay can be subject to the electrical fields or discharges during the manufacturing process that damage the microchip. Thus a fairly high level of scrap is generated by the current label making process. The microprocessor is typically the most costly component and minimizing the incidence of damage to the microprocessors may be highly desirable to reducing the scrap rate.

### SUMMARY

One exemplary embodiment of the invention describes a label. The label can include a substrate having a first surface and a second surface, with the first surface of the substrate having a circuit disposed thereon. The label may further have a laminate disposed over the first surface and the second surface, as well as a layer of adhesive disposed over at least part of the laminate. Additionally, there may be a release layer disposed over at least a portion of the adhesive layer.

In another exemplary embodiment, a method of making a label is described. The method can include a step for attaching a circuit to a first face of a substrate having a first face and a second face. Additionally, a laminate can be applied over the first face and the second face of the substrate after the circuit is attached. The method may further include applying an adhesive layer to the first face of the substrate and applying a release layer over the adhesive layer.

Another exemplary embodiment can describe a process for making an RFID label. The process can include means to dispose a microchip and an antenna on the first surface of a substrate having a first surface and a second surface. The process may further include means to print indicia on the first surface of the substrate and the second surface of the substrate and means to seal the substrate, the microchip, the antenna and the indicia from outside elements. This embodiment may also allow for means to apply adhesive to the sealing means of the substrate located proximate the first surface of the substrate. In addition, the process can have means to protectively cover the adhesive as well as means to remove the protective covering means from the adhesive.

In a further exemplary embodiment, a label and process of making the label are described. This embodiment may have a paper-based substrate having a first surface and a second surface. The label may also have an antenna disposed on the first surface of the substrate by printing with conductive ink. Further, the label can include a microchip disposed proximate the antenna on the first surface of the substrate and a seal disposed over the substrate by lamination of a polyethylene terephthalate. Additionally, the label may have an adhesive disposed over the seal and proximate the first surface of the substrate and a release layer disposed proximate the adhesive.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary perspective view of an RFID label.

FIG. 2 is an exemplary exploded view of an RFID label.

FIG. 3 is another exemplary exploded view of an RFID label.

FIG. 4 is an exemplary flowchart showing steps used in the fabrication of an RFID label.

FIG. 5 is an exemplary front view of an assembled RFID label.

FIG. 6 is an exemplary back view of an assembled RFID label.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

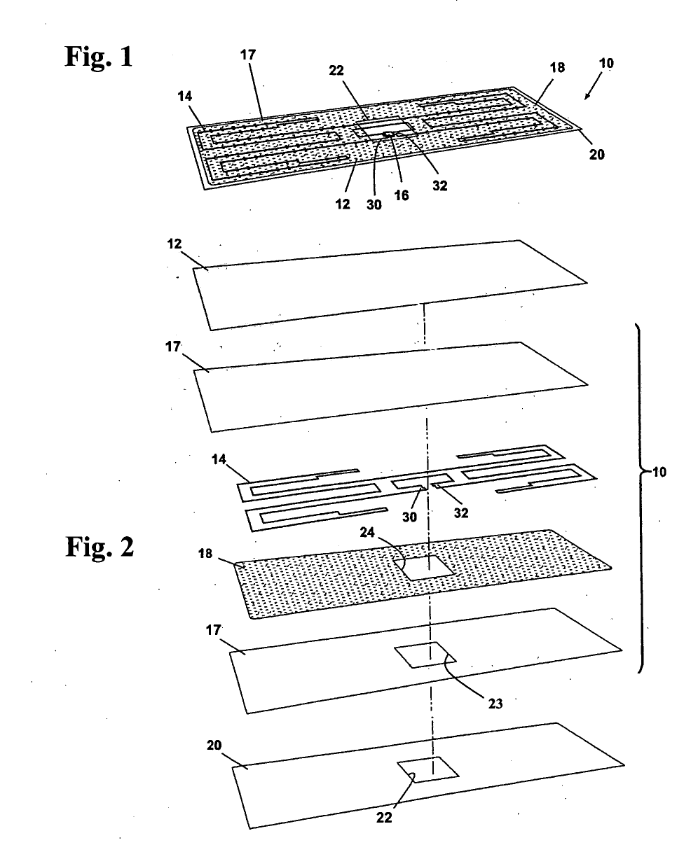

Generally referring to FIGS. 1-6, an RFID label and method of making the same are disclosed. The RFID tag may be manufactured using any of a variety of processes, for example a preconversion process. The RFID tag may further include an inlay, and a paper web onto which a variety of items, such as an antenna, a microchip and human and machine-readable indicia may be printed. The RFID tag may further be formed using a polyethylene terephthalate (PET) material.

FIGS. 1 and 2 show exemplary embodiments of an RFID tag in assembled and exploded form, respectively. In these embodiments, RFID label 10 could have a thin, flexible label substrate 12. Label substrate 12 can be any of a variety of materials. For example, label substrate 12 can be a paper-based material that allows for the printing of a circuit by using conductive ink, and the printing of other, traditional indicia using standard ink known to one having ordinary skill in the art. Further, an electrical circuit, shown in this exemplary embodiment as antenna 14, may be disposed on RFID label 10. Antenna 14 can include a thin layer of conductive material, for example, conductive ink, metal foil, sputter-deposited conductive material and the like, and may be disposed in a preselected configuration suitable for receiving and transmitting radio frequency signals of a preselected over a preseletced distance.

In a further exemplary embodiment, antenna 14 can be applied to label substrate 12 through a lithographic process using a commercially available conductive ink known to one having ordinary skill in the art. Antenna 14 may be configured with a pair of substantially opposed antenna contacts 30 and 32. However, in other embodiments, antennas of differing configurations and orientations can be utilized, depending on the requirements of a particular application. Additionally, circuits having functionality other than the receipt and transmission of radio frequency signals may be utilized with the embodiments as described herein. Label substrate 12 may then be imprinted on either or both a first surface, such as the surface where antenna 14 and microchip 16 are located, and a second surface of the substrate with visual information, such as human-readable and machine-readable indicia. The human-readable indicia can include such items as text and graphics; machine-readable indicia can include bar coding and other optically-readable information.

Still referring to FIGS. 1 and 2, label substrate 12 could also be wholly or partially coated with an additional laminate 17, for example, a polyethylene terephthalate (PET) liner, that is compatible with a chip attachment machine utilized in this process and the post-chip-attachment process (e.g. a printing process using Printronix). The PET liner may be transparent and impact-resistant, as well as providing a barrier from outside moisture, gases and other elements. Laminate 17 can alternatively be any type of material that is transparent or translucent. Additionally, laminate 17 may be waterproof and may act to seal RFID label from outside elements. An interior portion of laminate 17 may also be coated with a thin layer of adhesive so as to adhere to the substrate. RFID label 10 may also include adhesive layer 18. Adhesive layer 18 may be thin and may be suitable for adhering to PET layer 17 and a container (not pictured). Prior to adhering RFID tag 10 to a container, adhesive layer 18 may be covered and protected by a release layer 20. Release layer 20 may be disposed over all or part of adhesive 18 and may act to prevent adhesive 18 from adhering to any undesired object prior to the removal of release layer 20. Suitable adhesives to be used with adhesive layer 18 can include any known transfer adhesives, spray adhesives or UV adhesives. As described herein, label substrate 12, antenna 14, adhesive layer 18 and release layer 20 may be disposed in a layered configuration. Additionally, in at least one embodiment of the invention, visual information may be imprinted on label substrate 12 subsequent to the application of antenna 14, adhesive layer 18 and release layer 20 to label substrate 12.

Further, microchip 16 may be cooperatively disposed with antenna 14 through antenna contacts 30 and 32. Microchip 16 may have data storage, processing, transmitting and receiving capabilities and specifications suitable for the purposes described herein. Microchip 16 may also have passive UHF specifications, although microchips having active UHF specifications and other devices subject to a risk of damage during a label fabrication process such as a solar chip, a battery, a temperature sensor and the like may be incorporated into a label according to this exemplary embodiment of the invention.

Microchip 16 may further be prepared for a “direct die attach” or a “strap attach,” as are well known by one having ordinary skill in the art. Additionally, the term “microchip,” as used hereinafter, may refer to a microchip, a microprocessor, a strap, an interposer or any similar device known to one having ordinary skill in the art adapted for attachment to an antenna.

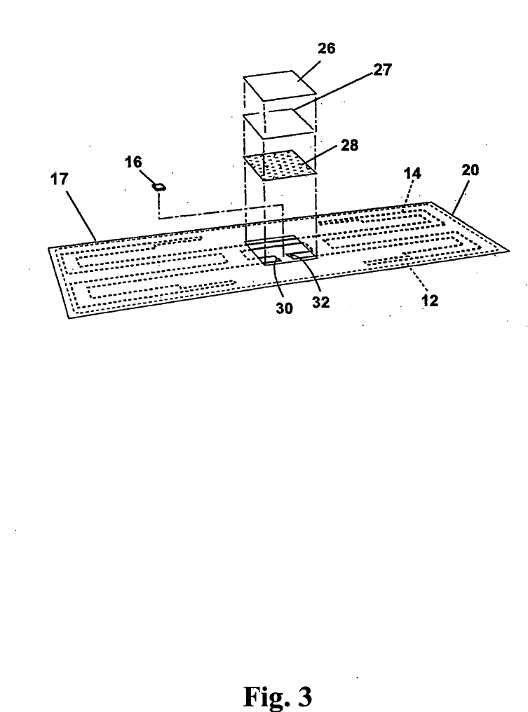

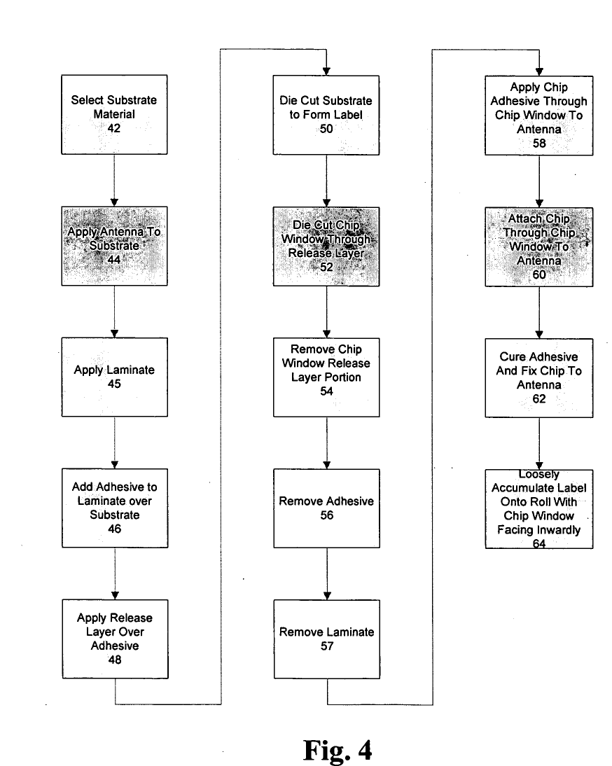

FIGS. 2, 3 and 4 refer to an exemplary embodiment dealing with RFID label fabrication. Specifically, FIG. 3 shows an exemplary fabrication of an RFID label and FIG. 4 outlines the steps in an exemplary fabrication. The process and steps illustrated in FIGS. 3 and 4 may, however, be modified based upon a particular label configuration, adhesive pattern, layer configuration and the like, as described hereinafter. In one embodiment, label substrate 12 can be provided as a paper-based web material and the following described process may be automated and conducted in a rapid sequence or concurrently on a plurality of labels. However, the process will be described with respect to a single label having a single microchip.

The process 40 may be initiated by the selection 42 of a label substrate 12 material having suitable properties for the intended label. The properties may include size, durability, color and the like. Antenna 14 may then be applied 44 to label substrate 12 in a preselected configuration, and any desired human-readable or machine readable indicia may be printed on label substrate 12 as well. Laminate 17 may then be applied 45 over the first and second surfaces of label substrate 12, including antenna 14 and any human or machine-readable indicia. In a further exemplary embodiment, laminate 17 may include a transparent adhesive (not pictured) disposed one either one interior surface of the laminate or both interior surfaces of the laminate, and the adhesive may act to adhere the laminate to label substrate 12. Label adhesive layer 18 may then be applied 46 over the first surface of label substrate 12 (e.g. the surface onto which antenna 14 has been printed) and laminate 17, and may be followed by the addition of release layer 20 in step 48.

Label substrate 12 may then be separated into individual labels, for example through a die cutting process. The die cutting step 50 can form perforations along a separation border for readily separating the labels along the perforations. Alternatively, die cutting step 50 may separate the labels from each other or may further cut selvage from the substrate to separate the labels into spaced-apart relationships and the selvage thus cut from the release layer 20 can be subsequently removed from the release layer 20. Additionally, die cutting step 50 and any selvage removal step may be carried out prior to the winding step 64. Chip first, second and third windows 22 23 and 24 may be cut 52 in release layer 20, label adhesive layer 18 and laminate 17 through a die cutting process known to one having ordinary skill in the art. Alternatively, chip window 22 can be cut in release layer 20 alone, leaving adhesive layer 18 and laminate 17 intact. The die cutting operation 50 is controlled utilizing any known registration method so that the cut does not extend into antenna 14. Chip window release layer portion 26 may then be removed 54. The adhesive portion 18 of chip window 24 may also be removed 56 if it is not removed during the removal of chip window release layer portion 26. Further, the laminate 27 portion may be removed 57 if it is not removed during the previous steps 54 or 56. Alternatively, if a transfer adhesive is utilized for adhesive layer 18, the transfer adhesive can be pre-cut with chip window 24, thereby eliminating step 56, i.e. the separate removal of the adhesive portion 28. Additionally, the chip window die cutting operation can either occur before or after the label cutting operation or may be conducted concurrently with it.

Still referring to FIGS. 2, 3 and 4, in an exemplary “direct die attach“process, a chip adhesive may be applied 58 through first, second and third chip windows 22, 23 and 24 to label substrate 12 intermediate antenna contacts 30 and 32. Microchip 16 may then be attached 60 to antenna contacts 30 and 32 by embedding microchip 16 in the chip adhesive through first, second and third chip windows 22, 23 and 24. Alternatively, in another exemplary embodiment, microchip 16 can be supplied with an adhesive already applied, thus obviating the separate chip adhesive application step 58. In yet another exemplary embodiment, microchip 16 may be applied in conjunction with antenna 14, obviating the need for the first, second and third chip windows. However, following the attachment of microchip 16 in the previous steps, label 10 may then be positioned intermediate a pair of machine-controlled thermodes which may be heated and brought together under carefully controlled conditions of temperature and pressure 62 known to one having ordinary skill in the art to cure the adhesive and fix the microchip 16 in the adhesive. Alternatively, the adhesive can be cured by other suitable methods known in the art, such as UV curing and the like.

Alternatively, in yet another exemplary embodiment, in order to facilitate the connection of microchip 16 to antenna 14, the microchip (conventionally referred to as a “strap” or “interposer”) can be provided with extension leads for connection to antenna contacts 30 and 32. The leads can be configured to enable microchip 16 to be connected to antenna 14 without having to precisely position microchip 16 relative to antenna contacts 30 and 32.

After the positioning of microchip 16, labels 10 may be loosely accumulated 64 onto a roller with first, second and third chip windows 22, 23 and 24 facing inwardly or in a fan-fold configuration. The finished labels 10 may then be removed form release layer 20 and applied to a carton, pallet, shipping container and the like.

In another exemplary embodiment, adhesive layer 18 can be applied to label substrate 12 under controlled conditions to eliminate adhesive in the area corresponding to chip windows 22 and 24, thus eliminating the need for separate removal of adhesive portion 28 from laminate 17 of label substrate 12. Similarly, adhesive layer 18 can be applied to label substrate 12 in two strips on either side of the chip window area. The two adhesive strips can be aligned on label substrate 12 longitudinally or laterally, or may cover predefined areas of substrate 12, for example, the corners.

In yet another embodiment, adhesive layer 18 and release layer 20 may be applied over the entirety of laminate 17 and label substrate 12 and a strip of release layer 20, with or without a strip of the adhesive layer 18 and the laminate layer 17, can then be removed to expose the microchip attachment area. The strip can be retained, such as on a roller, while microchip 16 is attached to antenna 14, as previously described. The strip can be reapplied to label substrate 12 over microchip 16 after the attachment and curing processes, followed by accumulating finished labels 10 onto a roller or in a fan-fold configuration.

In another exemplary embodiment, laminate 17, adhesive layer 18 and release layer 20 can be applied over the entirety of label substrate 12 on the surface opposite antenna 14 and microchip 16. Label 10, as applied, can then be attached to an item, such as a container, with antenna 14 and microchip 16 projecting outwardly from the item surface. Microchip 16 can be attached to antenna 14 in the final step of label fabrication and printing processes in order to minimize the possibility of damage to microchip 16.

As illustrated and described herein, microchip 16 may be located in a central position of antenna 14. However, microchip 16 may be positioned in any location on label 10, depending on the application. Additionally, a plurality of microchips may be used on an individual label 10. The plurality of microchips may require a plurality of windows to be die cut through one or all of the release layer 20, adhesive layer 18 and laminate 17 before positioning and attaching the plurality of microchips. Alternatively, a plurality of microchips may be attached prior to the application of the laminate 17, adhesive layer 18 and/or release layer 20.

Further, the process according to at least one exemplary embodiment can be carried out in a single or in multiple facilities. For example, the steps of printing and applying the circuits to the substrate, applying adhesive to the substrate and applying a release layer can be carried out at a label conversion facility, and the steps of applying the microchip to the circuit and connecting the microchip to the circuit can be carried out at an electronic manufacturing plant. Typically the steps of removing a portion of the release layer and the adhesive layer can be carried out at the label converter.

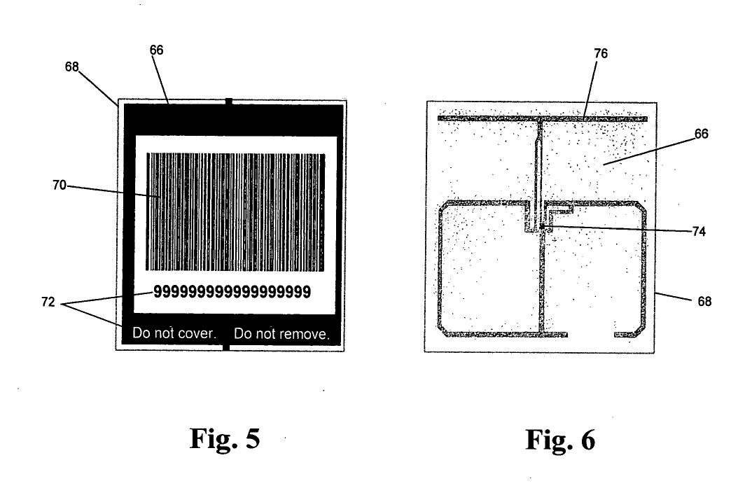

In a further exemplary embodiment shown in FIGS. 5 and 6, a front and back view of an assembled RFID label made from the process described with respect to the previous figures may be shown. In the front view shown in FIG. 5, RFID label 66 may be any dimension, for example about 80 mm by 80 mm. Laminate 68, which may be any material, for example PET, may be disposed over the entirety of RFID label 66 and may act seal the label from external elements. Additionally, the dimensions of the laminate 68 disposed over the inlay used for RFID label 66 may be larger than that of the label itself, for example about 100 mm wide by 88 mm high. The laminate 68 may be transparent, machine readable indicia, for example a barcode 70, and human readable indicia, for example, text and numbers 72, which may be visible through laminate 68.

FIG. 6 shows a back view of RFID label 66. In this view, laminate 68 may be seen at the peripheral edges and may act to completely cover and seal microchip 74 and antenna 76 of label 66. Additionally, microchip 74 is shown as disposed in a centralized location on RFID label 66. FIG. 6 does not show an adhesive layer, which may be applied and be substantially transparent or translucent. Additionally, in the back view of FIG. 6, a release layer is not shown as being applied to RFID label 66. As discussed previously, this is just one exemplary location for a microchip. Other embodiments of an RFID label may have a microchip located in a different location or a plurality of microchips located in various positions on an RFID label. Further, antenna 76 is shown in one possible orientation in FIG. 6. Other embodiments may have different orientations for an antenna or may utilize multiple antennas. Both microchip 74 and antenna 76 may be seen through laminate 68 because, similar to the adhesive layer, laminate 68 may be transparent or translucent.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A label, comprising:
a substrate having a first surface and a second surface, the first surface of the substrate having a circuit thereon;
a laminate disposed over the first surface and the second surface;
a layer of adhesive disposed over the laminate; and
a release layer covering the adhesive layer.

2. The label of claim 1, the circuit on the first surface further comprising:
an RFID inlay with at least one RFID microchip and at least one antenna.

3. The label of claim 2, wherein the RFID inlay is paper based.

4. The label of claim 1, further comprising:
a portion of the release layer having an opening to expose at least a portion of the circuit.

5. The label of claim 4, further comprising a portion of the laminate having an opening to expose at least a portion of the circuit.

6. The label of claim 1, further comprising:
an adhesive applied to an interior portion of the laminate.

7. The label of claim 1, wherein the laminate is polyethylene terephthalate (PET).

8. The label of claim 1, wherein the laminate extends beyond the edges of the label.

9. The label of claim 1, wherein the laminate acts to seal the label from outside elements.

10. The label of claim 1, wherein the laminate is transparent.

11. The label of claim 1, further comprising:
machine-readable indicia and human readable indicia printed of the second surface of the label.

12. The label of claim 10, wherein the machine-readable indicia is a barcode.

13. A method of making a label, comprising:
attaching a circuit to the first face of a substrate having a first face and a second face;
applying a laminate over the first face and the second face of the substrate;
applying an adhesive layer to the first face of the substrate; and
applying a release layer over the adhesive layer.

14. The method of claim 13, further comprising:
depositing and attaching at least one microchip to the circuit on the first substrate.

15. The method of claim 14, wherein the circuit is an antenna and the microchip is an RFID chip.

16. The method of claim 13, further comprising:
cutting a hole in the release layer, the adhesive layer and the laminate layer; and
positioning a microchip in contact with the circuit on the first face of the substrate.

17. The method of claim 13, further comprising:
disposing an adhesive on at least one interior surface of the laminating; and
adhering the laminate to the substrate.

18. The method of claim 13, wherein the laminate is polyethylene terephthalate (PET).

19. The method of claim 13, wherein the substrate is a paper-based RFID inlay.

20. The method of claim 19, further comprising:
printing the circuit on the RFID inlay using conductive ink.

21. The method of claim 19, further comprising:
printing machine-readable indicia and human-readable indicia on the RFID inlay.

22. The method of claim 13, further comprising:
sealing the RFID from outside elements with the laminate.

23. The method of claim 13, wherein the laminate is transparent.

24. A process for making an RFID label, comprising:
means to dispose a microchip and an antenna on the first surface of a substrate having a first surface and a second surface;
means to print indicia on the first surface of the substrate and the second surface of the substrate;
means to seal the substrate, the microchip, the antenna and the indicia from outside elements;
means to apply adhesive to the sealing means of the substrate located proximate the first surface of the substrate;
means to protectively cover the adhesive; and
means to remove the protective-covering means from the adhesive.

25. A label, comprising:
a paper-based substrate having a first surface and a second surface;
an antenna disposed on the first surface of the substrate by printing with conductive ink;
a microchip disposed proximate the antenna on the first surface of the substrate;
machine readable indicia and human readable indicia deposited on the second surface of the substrate by printing;
a seal disposed over the substrate by lamination of a polyethylene terephthalate;
an adhesive disposed over the seal and proximate the first surface of the substrate; and
a release layer disposed proximate the adhesive.
